(19) United States
(12) Patent Application Publication
(10) Pub. No.: US 2017/0131738 A1
(43) Pub. Date: May 11, 2017

(54) WEARABLE DEVICE

(71) Applicant: Chiun Mai Communication Systems, Inc., New Taipei (TW)

(72) Inventors: JENG-WEN LAI, Tu-Cheng (TW); YEN-HUI LIN, Tu-Cheng (TW)

(21) Appl. No.: 14/985,456

(22) Filed: Dec. 31, 2015

(30) Foreign Application Priority Data
Nov. 11, 2015 (CN) 201510764859.4

(51) Int. Cl. G06F 1/16; H01Q 1/27

(52) U.S. Cl. CPC G06F 1/163; H01Q 1/273

(57) ABSTRACT

A wearable device includes a frame, a circuit board, and a metallic member. The frame has a receiving space. The circuit board is received in the receiving space. The metallic member is received in the receiving space and is positioned above the circuit board. The circuit board feeds current to the metallic member and provides grounding to the metallic member, and the metallic member is configured to receive and send wireless signals.

### CROSS-REFERENCE TO RELATED APPLICATIONS

This application claims priority to Chinese Patent Application No. 201510764859.4 filed on Nov. 11, 2015, the contents of which are incorporated by reference herein.

### FIELD

The subject matter herein generally relates to a wearable device.

### BACKGROUND

Wearable devices, such as smart watches, bracelets, generally have a wireless communication function and include an antenna for establishing a wireless communication connection with other electronic devices, such as mobile phones, or personal digital assistants, for example.

### BRIEF DESCRIPTION OF THE DRAWINGS

Implementations of the present technology will now be described, by way of example only, with reference to the attached figures.

FIG. 1 is an elevational view of an embodiment of a wearable device.

FIG. 2 is an elevational view of a main body of the wearable device of FIG. 1.

FIG. 3 is a partially assembled, isometric view of the wearable device of FIG. 1.

FIG. 4 is a return loss graph of the wearable device of FIG. 1.

FIG. 5 is an efficiency graph of the wearable device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

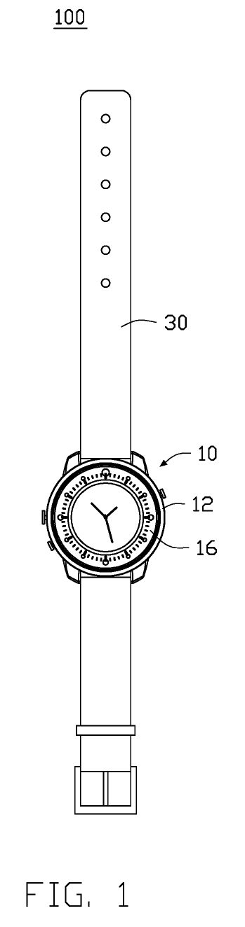

FIG. 1 illustrates an embodiment of a wearable device 100. For example, the wearable device 100 can be a bracelet, a smart watch, a glass, or a helmet. In this embodiment, the wearable device 100 is a smart watch.

The wearable device 100 includes a main body 10 and a connecting portion 30. The connecting portion 30 is attached to two opposite ends of the main body 10 and is configured to attach the wearable device 100 to a user so that an outer face surface of the main body 10 is positioned facing away from the user. In at least one embodiment, the connecting portion 30 can be a watchband of the smart watch.

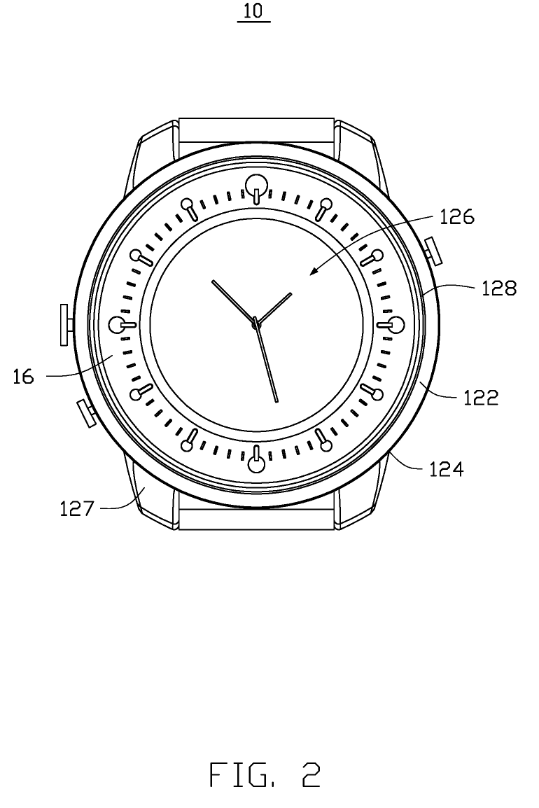

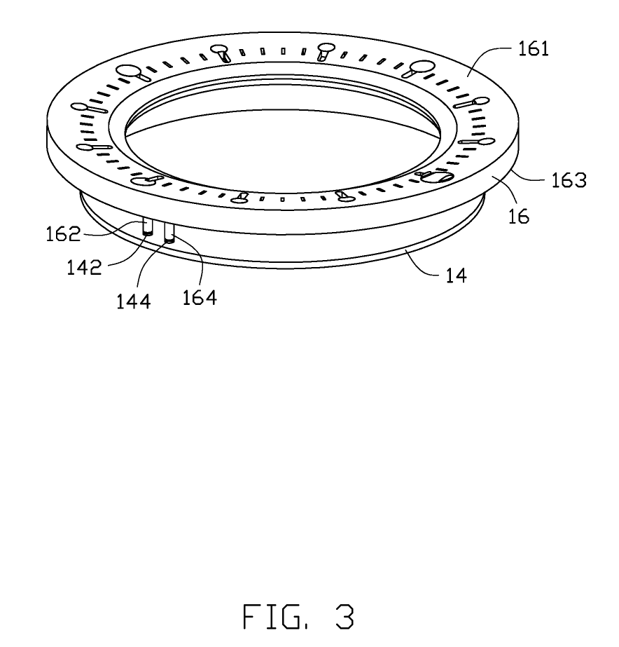

The main body 10 includes a frame 12, a circuit board 14 (shown in FIG. 3), and a metallic member 16. As illustrated in FIG. 2, the frame 12 is configured to fix the connecting portion 30. The frame 12 includes a first frame 122 and a second frame 124. The first frame 122 is detachably assembled to the second frame 124. The first frame 122 and the second frame 124 cooperatively form a ring structure with one end defining an opening and another end being closed. The first frame 122 and the second frame 124 further cooperatively form a receiving space 126 which is configured for receiving the circuit board 14 and the metallic member 16. In at least one embodiment, the second frame 124 includes two positioning arms 127. The two positioning arms 127 are positioned at two opposite ends of the second frame 124 and are configured to fix the connecting portion 30. One side of the first frame 122 away from the second frame 124 defines an opening 128. The opening 128 is configured to receive a display unit (not shown).

In at least one embodiment, the frame 12 is made of metal. It can be understood that, in other embodiments, the frame 12 can also be made of plastic.

FIG. 3 illustrates that the circuit board 14 includes a feed point 142 and a ground point 144. The feed point 142 is electrically connected to a radio frequency circuit (not shown) of the wearable device 100 for feeding current to the metallic member 16. The ground point 144 is electrically connected to a ground plane (not shown) of the wearable device 100 for grounding the metallic member 16.

The metallic member 16 is substantially ring-shaped and is positioned above the circuit board 14. The metallic member 16 is served as an antenna and is configured to receive/send wireless signals. In at least one embodiment, the metallic member 16 is a dial of the smart watch. The metallic member 16 includes a first surface 161 and a second surface 163 opposite to the first surface 161. The first surface 161 includes the marks and/or appliques of time of the smart watch. The second surface 163 faces the circuit board 14. The wearable device 100 further includes a feed end 162 and a ground end 164. In at least one embodiment, the feed end 162 is substantially a metallic cylinder. The feed end 162 is connected between the second surface 163 and the feed point 142 of the circuit board 14. The ground end 164 is substantially a metallic cylinder. The ground end 164 is connected between the second surface 163 of the metallic member 16 and the ground point 144 of the circuit board 14.

In assembly of the wearable device 100, the circuit board 14 is received in the receiving space 126. The metallic member 16 is positioned above the circuit board 14 through the feed end 162 and the ground end 164. The display unit is positioned on the metallic member 16 and is latched by the frame 12. When the frame 12 is made of metal, a periphery of the metallic member 16 is positioned apart from the frame 12. When the frame 12 is made of plastic, the periphery of the metallic member 16 can contact with the frame 12. The metallic member 16 is received in the receiving space 126 and does not contact with the user, which does not affect the receiving/sending of the wireless signals.

When the wearable device 100 is operated, current enters the feed end 162 through the feed point 142 and flows to the metallic member 16. The metallic member 16 serves as a loop antenna and thus the wearable device 100 can work at a working frequency band of about 2.4-2.45 GHz by adjusting the positions of the feed point 142 and the ground point 144 in order to transmit and/or receive wireless signals.

In other embodiments, the feed end 162 can be replaced by a microstrip line. One end of the microstrip line is electrically connected to the feed point 142. The other end of the microstrip line is positioned parallel with the metallic member 16, thereby the current is coupled to the metallic member 16.

In other embodiments, the wearable device 100 further includes a matching circuit (not shown). The matching circuit is positioned on the circuit board 14 and includes a plurality of capacitors and inductors. The matching circuit is electrically connected to the feed point 142 or the ground point 144 and is configured to match an impedance of the wearable device 100 for optimizing performance of the wearable device 100.

In other embodiments, the metallic member 16 can be other shapes. For example, one portion of the dial of the smart watch is made of metal, thereby forming the metallic member 16. The other portion of the dial is made of plastic and is integrated with the metallic member 16 by means of injection molding.

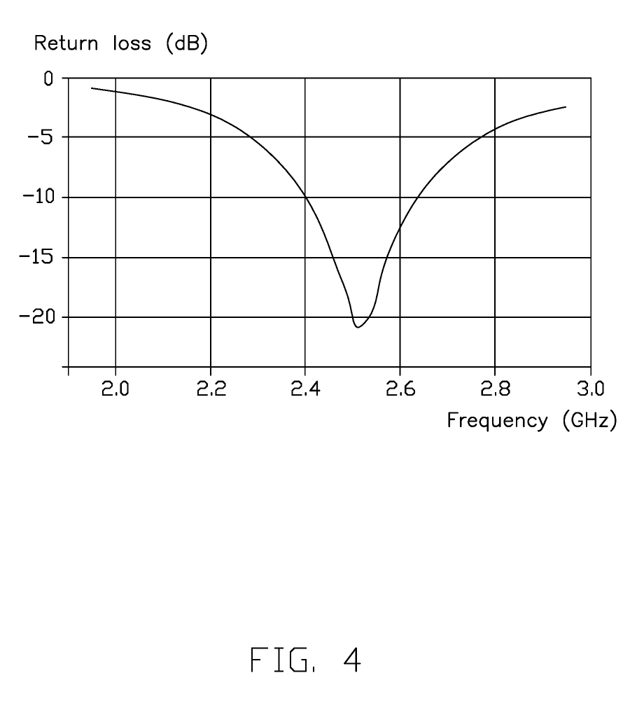

FIG. 4 illustrates a return loss (RL) measurement of the wearable device 100. It can be derived from FIG. 4 that the wearable device 100 can be utilized in at least at a common wireless communication system, such as WIFI (2.4-2.45 GHz), with exceptional communication quality.

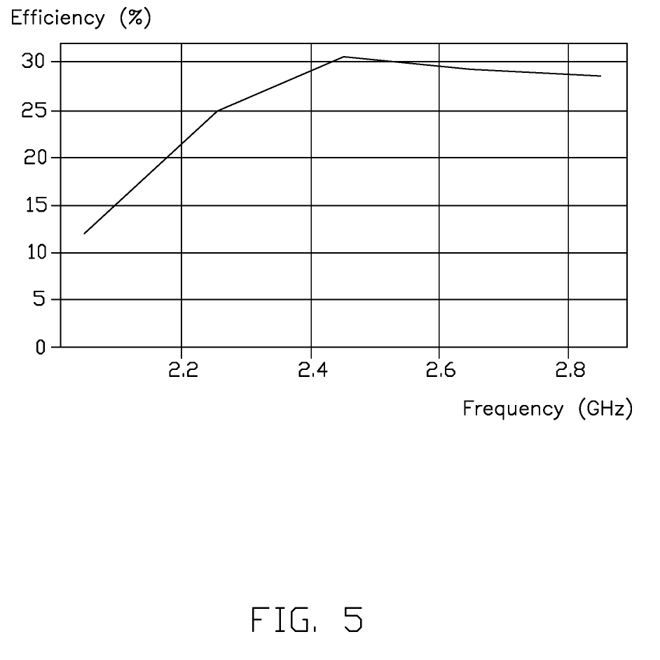

FIG. 5 illustrates an efficiency graph of the wearable device 100 attached at a wrist of the user. The wearable device 100 has a good performance when operating at WIFI band (2.4-2.45 GHz).

The embodiments shown and described above are only examples. Many details are often found in the art such as the other features of the antenna structure and the wireless communication device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wearable device comprising:
a frame having a receiving space;
a circuit board received in the receiving space; and
a metallic member received in the receiving space and positioned above the circuit board;
wherein the circuit board feeds current to the metallic member and provides ground for the metallic member, and the metallic member is configured to receive and send wireless signals.

2. The wearable device of claim 1, wherein the circuit board comprises a feed point and a ground point, the feed point is configured to feed current to the metallic member and the ground point is configured to ground the metallic member.

3. The wearable device of claim 2, wherein the metallic member comprises a first surface and a second surface opposite to the first surface, the wearable device further comprises a feed end and a ground end, the feed end is connected between the second surface and the feed point of the circuit board, and the ground end is connected between the second surface of the metallic member and the ground point of the circuit board.

4. The wearable device of claim 3, wherein the metallic member is a dial and the first surface comprises marks and/or appliques of time.

5. The wearable device of claim 3, wherein the metallic member is substantially ring-shaped.

6. The wearable device of claim 1, wherein the frame comprises a first frame and a second frame, the first frame is detachably assembled to the second frame and cooperatively forms the receiving space with the second frame.

7. The wearable device of claim 1, further comprising a connecting portion, wherein the connecting portion is attached to two opposite ends of the frame.

8. A wearable device comprising:
a main body comprising:
a frame;
a circuit board received in the frame; and
a dial received in the frame; and
wherein the dial is positioned above the circuit board and cooperatively forms an antenna loop with the circuit board.

9. The wearable device of claim 8, wherein the circuit board comprises a feed point and a ground point, the feed point is configured to feed current to the dial and the ground point is configured to ground the dial.

10. The wearable device of claim 9, wherein the dial comprises a first surface and a second surface opposite to the first surface, the first surface comprises marks and/or appliques of time, the wearable device further comprises a feed end and a ground end, the feed end is connected between the second surface of the dial and the feed point of the circuit board, and the ground end is connected between the second surface of the dial and the ground point of the circuit board.

11. The wearable device of claim 8, wherein the dial is substantially ring-shaped.

12. The wearable device of claim 8, wherein the frame comprises a first frame and a second frame, the first frame is detachably assembled to the second frame and cooperatively forms a receiving space with the second frame for receiving the circuit board and the dial.

13. The wearable device of claim 8, further comprising a connecting portion, wherein the connecting portion is attached to two opposite ends of the frame.
